(19) United States
(12) Patent Application Publication
(10) Pub. No.: US 2019/0204761 A1
(43) Pub. Date: Jul. 4, 2019

(54) MAGNETIC CORE MATERIAL FOR ELECTROPHOTOGRAPHIC DEVELOPER, CARRIER FOR ELECTROPHOTOGRAPHIC DEVELOPER, DEVELOPER, METHOD FOR PRODUCING MAGNETIC CORE MATERIAL FOR ELECTROPHOTOGRAPHIC DEVELOPER, METHOD FOR PRODUCING CARRIER FOR ELECTROPHOTOGRAPHIC DEVELOPER, AND METHOD FOR PRODUCING DEVELOPER

(71) Applicant: POWDERTECH CO., LTD., Kashiwa-shi, Chiba (JP)

(72) Inventors: Hiroki SAWAMOTO, Kashiwa-shi, Chiba (JP); Tetsuya UEMURA, Kashiwa-shi, Chiba (JP)

(21) Appl. No.: 15/779,501

(22) PCT Filed: Mar. 6, 2018
(86) PCT No.: PCT/JP2018/008657

§ 371 Date: May 25, 2018

(30) Foreign Application Priority Data
Aug. 25, 2017 (JP) 2017-162630

(51) Int. Cl. G03G 9/107; G03G 9/113; G03G 9/08

(52) U.S. Cl. CPC G03G 9/1075; G03G 9/0819; G03G 9/1139; G03G 9/1131

(57) ABSTRACT

To provide a magnetic core material for electrophotographic developer and carrier for electrophotographic developer which are excellent in a rising-up of charge amount, can suppress a carrier scattering, and can stably provide good images; a developer containing the carrier; a method for producing the magnetic core material for electrophotographic developer; a method for producing the carrier for electrophotographic developer; and a method for producing the developer.

The magnetic core material for electrophotographic developer, containing a sulfur component in a content of from 1 to 45 ppm in terms of a sulfate ion.

### TECHNICAL FIELD

The present invention relates to a magnetic core material for electrophotographic developer, a carrier for electrophotographic developer, a developer, a method for producing the magnetic core material for electrophotographic developer, a method for producing the carrier for electrophotographic developer, and a method for producing the developer.

### BACKGROUND ART

The electrophotographic development method is a method in which toner particles in a developer are made to adhere to electrostatic latent images formed on a photoreceptor to develop the images. The developer used in this method is classified into a two-component developer composed of a toner particle and a carrier particle, and a one-component developer using only a toner particle.

As a development method using the two-component developer composed of a toner particle and a carrier particle among those developers, a cascade method and the like were formerly employed, but a magnetic brush method using a magnet roll is now in the mainstream. In the two-component developer, a carrier particle is a carrier substance which is agitated with a toner particle in a development box filled with the developer to impart a desired charge to the toner particle, and further transports the charged toner particle to a surface of a photoreceptor to form toner images on the photoreceptor. The carrier particle remaining on a development roll to hold a magnet is again returned from the development roll to the development box, mixed and agitated with a fresh toner particle, and used repeatedly in a certain period.

In the two-component developer, unlike a one-component developer, the carrier particle has functions of being mixed and agitated with a toner particle to charge the toner particle and transporting the toner particle to a surface of a photoreceptor, and it has good controllability on designing a developer. Therefore, the two-component developer is suitable for using in a full-color development apparatus requiring a high image quality, a high-speed printing apparatus requiring reliability for maintaining image and durability, and the like. In the two-component developer thus used, it is needed that image characteristics such as image density, fog, white spots, gradation, and resolving power exhibit predetermined values from the initial stage, and additionally these characteristics do not vary and are stably maintained during the durable printing period (i.e., a long period of time of use). In order to stably maintain these characteristics, characteristics of a carrier particle contained in the two-component developer need to be stable.

As a carrier particle forming the two-component developer, an iron powder carrier such as an iron powder covered on its surface with an oxide film or an iron powder coated on its surface with a resin, has conventionally been used. However, since such an iron powder carrier has a true specific gravity as heavy as about 7.8 and has a too high magnetization, agitation and mixing thereof with a toner particle in a development box is liable to generate fusing of toner-constituting components on the iron powder carrier surface, that is, so-called toner spent. Such generation of toner spent reduces an effective carrier surface area, and is liable to decrease the frictional chargeability to a toner particle. In addition, in a resin-coated iron powder carrier, a resin on the surface is peeled off due to agitation stress during the durable printing or mechanical stress such as collision of particles with each other, impact, friction, or stress occurred between particles in a development box, and a core material (iron powder) having a high conductivity and a low dielectric breakdown voltage is exposed, thereby causing the leakage of the charge in some cases. Such leakage of the charge causes the breakage of electrostatic latent images formed on a photoreceptor and the generation of brush streaks on solid portions, thus hardly providing uniform images. For these reasons, the iron powder carrier such as an oxide film-covered iron powder and a resin-coated iron powder has not been used currently.

In recent years, in place of the iron powder carrier, a ferrite carrier having a true specific gravity as light as about 5.0 and also has a low magnetization, and a resin-coated ferrite carrier having a resin coated on its surface have often been used, whereby the developer life has been remarkably prolonged. A method for producing such a ferrite carrier generally involves mixing ferrite carrier raw materials in predetermined amounts, thereafter calcining and pulverizing the mixture, and granulating and thereafter sintering the resultant. The calcination may be omitted in some cases, depending on the condition.

Recently, networking of offices progresses, and the time changes from a single-function copying machine to a multifunctional machine. In addition, a service system also shifts from a system where a service person who contracts to carry out regular maintenance and to replace a developer or the like to the time of a maintenance-free system. The demand for further extending the life of the developer from the market is increasing more and more.

Under these circumstances, in order to attempt to improve carrier characteristics, it has been proposed to control a shape or an amount of impurities of carrier core material. For example, Patent Literature 1 (JP-A-2005-106999) proposes a carrier for electrostatic latent image developer containing a magnetic carrier core material having a specific resin coating layer formed on its surface, in which the magnetic carrier core material has an envelope coefficient A represented by formula (1):

A=[(L₁−L₂)/L₂]×100

(in the formula, L₁ represents an outer peripheral length of projection image of the carrier core material, and L₂ represents a length of envelope of projection image of the carrier core material) satisfying relation of A<4.5. This carrier is described to have a stable charging imparting ability for a long period of time and an effect of suppressing occurrence of carrier adhesion or the like. In particular, it is described that by setting the envelope coefficient A to be low, uneven distribution of resin on the surface of core material is decreased to make the resin layer uniform, exposure of the core material due to wear with time decreases and carrier adhesion to the non-image area due to charge injection from the carrier hardly occurs.

In addition, Patent Literature 2 (JP-A-2012-181398) proposes a ferrite carrier core material for electrophotographic developer having a magnetization by VSM measurement when applied a magnetic field of 1K·1000/4π·A/m being from 50 to 65 Am²/kg, a BET specific surface area being from 0.12 to 0.30 m²/g, an average particle diameter being from 20 to 35 μm, and a perimeter/envelope length in number distribution satisfying the range in which 1.02 or more and less than 1.04 is from 75% by number to 90% by number and 1.04 or more and less than 1.06 is 20/% by number or less. This carrier core material is described to have excellent charging property and an effect of suppressing occurrence of carrier scattering. In particular, it is described that by setting the perimeter/envelope length to be within the specific range, the carrier is suppressed from being low in resistance to scatter, which is caused as a result of a resin coated on the convex portion of the carrier peeling preferentially due to agitation in a developing machine. In addition, it is described to reduce a chlorine amount and described that in the case where the carrier core material contains chlorine, the chlorine adsorbs moisture in use environment to influence on electrical characteristics including the charging amount.

Moreover, Patent Literature 3 (JP-A-2016-025288) proposes a ferrite magnetic material containing Fe as a main component and an additional element such as Mn, in which an average particle diameter is from 1 to 100 μm, the total amount of impurities in the ferrite magnetic material excluding Fe, the additional element and oxygen is 0.5% by mass or less, and the impurities include at least two selected from Si, Al, Cr, Cu, P, Cl, Ni, Mo, Zn, Ti, sulfur, Ca, Mn, and Sr. It is described that a magnetic carrier using the ferrite magnetic material, in which influence of the impurities in the raw materials is suppressed, as a magnetic carrier core material for electrophotographic developer, has high magnetic force and an effect of suppressing the carrier scattering.

### CITATION LIST

### Patent Literature

Patent Literature 1: JP-A-2005-106999

Patent Literature 2: JP-A-2012-181398

Patent Literature 3: JP-A-2016-025288

### SUMMARY OF INVENTION

As described above, the attempts for improving the carrier characteristics by controlling a shape of carrier core material or an amount of impurities have been known, but, there is a problem in that the carrier characteristics are not sufficient for further demands of high image quality and high speed printing in recent years. In particular, it is strongly required not only to increase the rising-up speed of charge amount of carrier, but also to further reduce the carrier scattering. This is because when the rising-up speed of charge amount is low, the charge amount does not rise rapidly after toner supply to generate toner scattering or image defects such as fog. Furthermore, when the carrier scattering is large, white spots occur on the image or the carrier scattered damages a photoreceptor. As described above, although the attempts for improving the carrier characteristics have been made, characteristics of carrier core material are important in order to improve the carrier characteristics. This is because when the carrier is used for a long period of time, a resin coating layer is peeled off by the wear with time and the core material exposed has a large influence on the characteristics of carrier.

As iron oxide that is a raw material of ferrite used in a carrier core material, iron oxide by-produced in a hydrochloric acid pickling step of steel production is generally used, and this iron oxide contains a sulfur component as impurities. However, since the sulfur component has a small inhibition effect on sintering of ferrite and a small corrosion to production equipment, and there exists a reciprocal relationship in that increase in the quality of raw material leads to decrease in economic efficiency, it has been conventionally considered that the sulfur component is not an important quality index of iron oxide.

Now, the present inventors have found that the content of sulfur component in a magnetic core material for electrophotographic developer is important for attempting improvement in charge characteristics and reduction in carrier scattering. Specifically, it has been found that by appropriately controlling the content of sulfur component in a magnetic core material for electrophotographic developer, when a carrier or a developer is formed therefrom, the rising-up of charge amount is excellent and the carrier scattering can be suppressed, thereby stably obtaining good images.

Therefore, an object of the present invention is to provide a magnetic core material for electrophotographic developer which is excellent in the rising-up of charge amount, can suppress the carrier scattering, and can stably obtain good images. Another object of the present invention is to provide a carrier for electrophotographic developer and a developer each of which has the magnetic core material. A further object of the present invention is to provide a method for producing the magnetic core material for electrophotographic developer, a method for producing the carrier for electrophotographic developer, and a method for producing the developer.

The objects of the present invention can be solved by the means described below.

[1] A magnetic core material for electrophotographic developer, containing a sulfur component in a content of from 1 to 45 ppm in terms of a sulfate ion.
[2] The magnetic core material for electrophotographic developer according to [1], in which in a number distribution of a ratio A of a perimeter to an envelope perimeter, a ratio of particles having the ratio A of 1.08 or more is 10% or less.
[3] The magnetic core material for electrophotographic developer according to [1] or [2], in which the content of the sulfur component is from 2 to 30 ppm in terms of a sulfate ion.
[4] The magnetic core material for electrophotographic developer according to [2], in which the ratio of particles having the ratio A of 1.08 or more is 8% or less.
[5] The magnetic core material for electrophotographic developer according to any one of [1] to [4], in which the magnetic core material has a volume average particle diameter (D₅₀) being from 25 to 50 μm, and an apparent density (AD) being from 2.0 to 2.7 g/cm³.
[6] The magnetic core material for electrophotographic developer according to any one of [1] to [5], in which the magnetic core material has a pore volume being from 0.1 to 20 mm/g.
[7] The magnetic core material for electrophotographic developer according to any one of [1] to [6], in which the magnetic core material has a ferrite composition containing at least one element selected from Mn, Mg, Li, Sr, Si, Ca, Ti, and Zr.
[8] A carrier for electrophotographic developer containing the magnetic core material for electrophotographic developer as described in any one of [1] to [7] and a coating layer containing a resin provided on a surface of the magnetic core material.
[9] A developer containing the carrier as described in [8] and a toner.
[10] A method for producing the magnetic core material for electrophotographic developer as described in any one of [1] to [7],

in which the method includes the following steps:
a step of pulverizing and mixing raw materials of the magnetic core material to produce a pulverized product,
a step of calcining the pulverized product to produce a calcined product,
a step of pulverizing and granulating the calcined product to produce a granulated product,
a step of sintering the granulated product to produce a sintered product, and
a step of disintegrating and classifying the sintered product; and

in which in the production of the granulated product, a washing operation is performed in a manner that water is added to the calcined product, followed by performing wet pulverization to form a slurry, and after dehydrating the slurry obtained, water is added again, followed by performing wet pulverization.

[11] The method for producing the magnetic core material for electrophotographic developer according to [10], in which in the washing operation, a step of adding water after dehydration of the slurry, followed by performing wet pulverization is repeated.
[11] A method for producing a carrier for electrophotographic developer including: producing a magnetic core material by the method as described in [10] or [11] and then, coating a surface of the magnetic core material with a resin.
[13] A method for producing a developer including:

producing a carrier by the method as described in [12] and then,

mixing the carrier with a toner.

### BRIEF DESCRIPTION OF DRAWINGS

FIG. 1 It shows a relation between the content of the sulfur component in a magnetic core material and the rising-up speed (RQ) of charge amount.

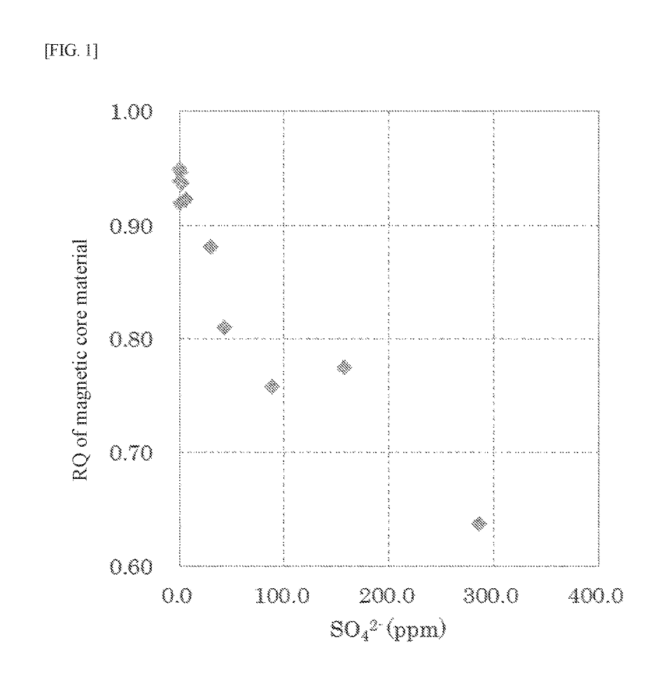

FIG. 2 It shows a relation between the content of the sulfur component in a magnetic core material and the number ratio (uneven particle ratio) of particles having a ratio A of perimeter to envelope perimeter being 1.08 or more.

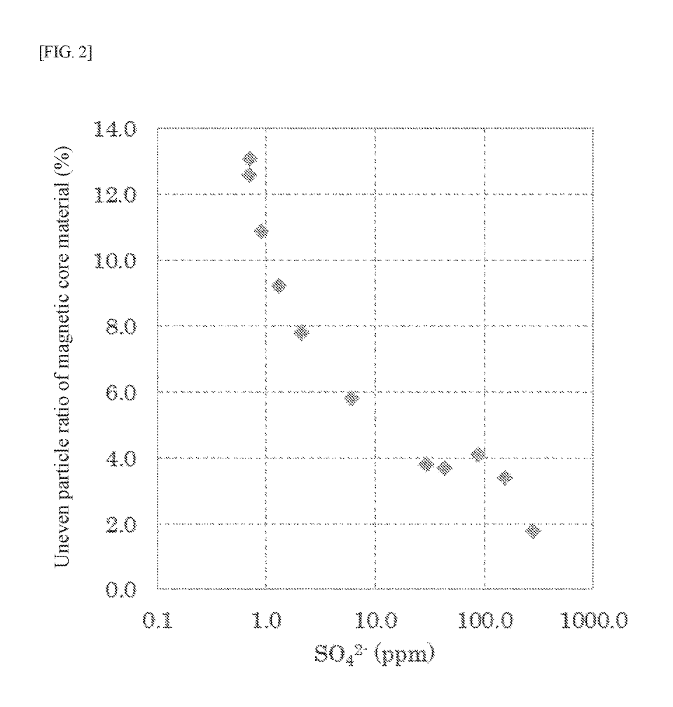

### DESCRIPTION OF EMBODIMENTS

In the specification, a numerical value range represented by using “to” means a range including numerical values given before and after “to” as a lower limit value and an upper limit value, respectively.

The magnetic core material for electrophotographic developer is a particle capable of being used as a carrier core material, and the carrier core material is coated with a resin to form a magnetic carrier for electrophotographic developer. An electrophotographic developer is formed by containing the magnetic carrier for electrophotographic developer and a toner. Magnetic core material for electrophotographic developer:

The magnetic core material for electrophotographic developer according to the present invention (hereinafter, referred to as a magnetic core material or a carrier core material in some cases) has a feature that the content of a sulfur component in the magnetic core material is controlled to be within a range from 1 to 45 ppm in terms of a sulfate ion (SO₄²⁻). According to such a magnetic core material, a carrier which is excellent in the rising-up of charge amount and suppresses the carrier scattering can be obtained. In the case where the content of a sulfur component exceeds 45 ppm, the rising-up speed of charge amount decreases. The reason for this is considered that since the sulfur component is hygroscopic, in the case where the content of a sulfur component is too large, moisture content of magnetic core material and carrier increases, thereby decreasing charging imparting ability and in addition, during the agitation of carrier and toner in the developer, the sulfur component in the carrier migrates to the toner, thereby decreasing the chargeability of toner. On the other hand, in the case where the content of a sulfur component is less than 1 ppm, a problem of the carrier scattering is a matter of concern. The reason for this is that in the case where the content of a sulfur component in the magnetic core material is excessively small, mutual sintering of particles is liable to occur during the sintering and the ratio of production of particles (magnetic core material) having large surface unevenness excessively increases. In addition, in order to produce the magnetic core material having the content of a sulfur component of less than 1 ppm, it is necessary to use a raw material having extremely high quality (low content of a sulfur component) or to pass through a specific step for increasing the quality and thus, there is a problem of poor productivity. The content of a sulfur component is preferably from 1.5 to 40 ppm, and more preferably from 2.0 to 30 ppm, on a weight basis.

The content of a sulfur component in the magnetic core material is obtained in terms of a sulfate ion. This does not mean that the sulfur component in the magnetic core material is limited to that contained in the form of a sulfate ion, and the sulfur component may be contained in the form of elemental sulfur, a metal sulfide, a sulfate ion, other sulfides or the like. The content of a sulfur component can be measured by, for example, a combustion ion chromatography method. The combustion ion chromatography method is a technique in which a sample is burned in oxygen-containing gas flow, the gas generated is absorbed in an adsorption solution and then, a halogen or a sulfate ion adsorbed in the adsorption solution is quantitatively analyzed by an ion chromatography method. The technique makes it possible to easily analyze a halogen or sulfur component in ppm order which has been conventionally difficult.

The value of the content of a sulfur component in terms of a sulfate ion described in the specification is a value measured by the combustion ion chromatography method under the conditions described in Examples described later.

As to the magnetic core material, in a number distribution of a ratio A of perimeter to envelope perimeter, a ratio of particles having the ratio A of 1.08 or more (hereinafter, referred to as “uneven particle ratio”) is preferably 10% or less, more preferably 9% or less, and still more preferably 8% or less. The lower limit of the uneven particle ratio is not particularly limited and is typically 0.1% or more. Furthermore, as to the magnetic core material, an average value of the ratio A is preferably from 1.01 to 1.07, more preferably from 1.02 to 1.06, and still more preferably from 1.03 to 1.05. The ratio A is a ratio of perimeter to envelope perimeter of individual particles constituting the magnetic core material and can be determined by the formula shown below.

The values of envelope perimeter and perimeter described in the specification are values obtained by observing 3,000 pieces of magnetic core materials by using a particle size and shape distribution measuring device (PITA-1, produced by Seishin Enterprise Co., Ltd.) under the conditions described in Examples described later and determining by using a software (Image Analysis) associated therewith.

Ratio A=perimeter/envelope perimeter [Math. 1]

The perimeter is a length of a circumference including unevenness of a projection image of an individual particle constituting the magnetic core material, and the envelope perimeter is a length obtained by connecting the individual convex portions of the projection image by ignoring the concave portions. Since the envelope perimeter is a length obtained by ignoring the concave portions of the particle, a degree of the unevenness of an individual particle constituting the magnetic core material can be evaluated from the ratio between the perimeter and the envelope perimeter. Namely, as the ratio A is close to 1, it means a particle having a small surface unevenness, and as the ratio A is large, it means a particle having a large surface unevenness. Therefore, in the number distribution of the ratio A, as the ratio of particles having the ratio A of 1.08 or more (uneven particle ratio) is small, a ratio of particles having a large surface unevenness in the magnetic core material is decreased.

Decrease in the uneven particle ratio of the magnetic core material is expected to further suppress the carrier scattering. This is because when the magnetic core material is subjected to resin coating to form a carrier, in particles having a large surface unevenness, the resin coating is easily peeled off from the convex portions thereof. Namely, mechanical stress is applied to the carrier by being mixed and agitated with a toner during its use, and in the case where the ratio of particles having a large surface unevenness is large, the resin coating of the carrier is liable to be peeled off due to the mechanical stress. When the resin coating of the carrier is peeled off, resistance of the carrier becomes too low, thereby causing the carrier scattering. Therefore, by decreasing the uneven particle ratio as 10% or less, the effect of suppressing the carrier scattering can be remarkably achieved.

As to the magnetic core material, as long as it functions as a carrier core material, the composition thereof is not particularly limited and conventionally known composition may be used. The magnetic core material typically has a ferrite composition (ferrite particle) and preferably has a ferrite composition containing at least one element selected from Mn, Mg, Li, Sr, Si, Ca, Ti and Zr. On the other hand, in consideration of the recent trend of the environmental load reduction including the waste regulation, it is desirable that heavy metals such as Cu, Zn and Ni are not contained in a content exceeding inevitable impurities (associated impurities) range.

The volume average particle size (D₅₀) of the magnetic core material is preferably from 25 to 50 μm, and more preferably from 30 to 45 μm. In the case where the volume average particle size is 25 μm or more, the carrier adhesion can be sufficiently suppressed. On the other hand, in the case of 50 μm or less, image degradation due to decrease in charging imparting ability can be further suppressed.

The apparent density (AD) of the magnetic core material is preferably from 2.0 to 2.7 g/cm³, and more preferably from 2.1 to 2.6 g/cm³. In the case where the apparent density is 2.0 g/cm³ or more, excessive weight saving of the carrier is suppressed and the charging imparting ability is further improved. On the other hand, in the case of 2.7 g/cm³ or less, the effect of weight saving of the carrier is sufficient and durability is further improved.

The pore volume of the magnetic core material is preferably from 0.1 to 20 mm³/g, and more preferably from 1 to 10 mm³/g. In the case where the pore volume is within the range described above, adsorption of moisture in the air is suppressed and environmental change of the charge amount is decreased, and in addition, since impregnation of resin into the inside of the core material is suppressed at the resin coating, a large amount of the resin need not be used.

In addition, as to the magnetic core material, the rising-up speed (RQ) of charge amount is preferably 0.80 or more, and more preferably 0.85 or more. In the case where the rising-up speed of charge amount is 0.80 or more, the charge of carrier also rises rapidly and as a result, in the case of forming a developer together with a toner, at an initial stage after toner supply, toner scattering and image defects such as fog are further suppressed. The upper limit of the rising-up speed (RQ) of charge amount is not particularly limited and is typically 1.00 or less.

The charge amount (Q) and the rising-up speed (RQ) thereof can be measured, for example, in the following manner. Namely, a sample and a commercially available negatively chargeable toner used in full-color printer are weighed so as to attain the toner concentration of 10.0% by weight and the total weight of 50 g. The sample and toner weighed are exposed under a normal temperature and normal humidity environment of temperature from 20 to 25° C. and relative humidity from 50 to 600% for 12 hours or more. Then, the sample and toner are charged into a 50-cc glass bottle and agitated at a rotation frequency of 100 rpm for 30 minutes to form a developer. On the other hand, as a charge amount measuring apparatus, use is made of an apparatus having a magnet roll including a total 8 poles of magnets (magnetic flux density: 0.1 T) which N poles and S poles are alternately arranged on an inner side of an aluminum bare tube (hereinafter, a sleeve) of a cylindrical shape of 31 mm in diameter and 76 mm in length, and a cylindrical electrode arranged in an outer circumference of the sleeve with a gap of 5.0 mm from the sleeve. On the sleeve is uniformly adhered 0.5 g of the developer and then, while the magnet roll on the inner side is rotated at 100 rpm with the outer-side aluminum bare tube being fixed, a direct current voltage of 2,000 V is applied for 60 seconds between the outer electrode and the sleeve to transfer the toner to the outer-side electrode. At this time, an electrometer is connected to the cylindrical electrode to measure the charge amount of the toner transferred. After the elapse of 60 seconds, the voltage applied is shut off, and after the rotation of the magnet roll is stopped, the outer-side electrode is taken out and the weight of the toner transferred to the electrode is measured. From the charge amount measured and the weight of the toner transferred, the charge amount (Q₃₀) is calculated. In addition, the charge amount (Q₂) is obtained in the same procedure as in the charge amount (Q₃₀) except for changing the agitation time of the sample and the toner to 2 minutes. The rising-up speed (RQ) of charge amount is determined from the formula shown below. As the numeric value is close to 1, it means that the rising-up speed of charge amount is high.

RQ=Q/Q₃₀ [Math. 2]

As described above, the magnetic core material (carrier core material) for electrophotographic developer of the present invention can form a carrier which is excellent in the rising-up of charge amount, can be suppressed the carrier scattering, and can stably provide good images, by controlling the content of a sulfur component to the range from 1 to 45 ppm in terms of a sulfate ion. As long as the present inventors know, the technique of controlling the sulfur component to the range described above has not been conventionally known. For example, in Patent Literature 2, although the Cl elution amount of the carrier core material is described, the sulfur component is not mentioned at all. Furthermore, in Patent Literature 3, the total amount of impurities in the ferrite magnetic material is defined, but this literature only focuses on decreasing the total amount of the impurities as much as possible and does not teach to control the content of a sulfur component to the specific range.

### Carrier for Electrophotographic Developer:

The carrier for electrophotographic developer of the present invention contains the magnetic core material described above and a coating layer containing a resin provided on the surface of the magnetic core material. The carrier characteristics may by influenced by materials present on the surface of the carrier or properties thereof. Therefore, by coating an appropriate resin on the surface, the desired carrier characteristics can be accurately controlled.

The coating resin is not particularly limited. Examples thereof include a fluorine resin, an acrylic resin, an epoxy resin, a polyamide resin, a polyamide imide resin, a polyester resin, an unsaturated polyester resin, a urea resin, a melamine resin, an alkyd resin, a phenol resin, a fluoroacrylic resin, an acryl-styrene resin, a silicone resin, and a modified silicone resin modified with a resin such as an acrylic resin, a polyester resin, an epoxy resin, a polyamide resin, a polyamide imide resin, an alkyd resin, a urethane resin, or a fluorine resin, and the like. In consideration of elimination of the resin due to the mechanical stress during usage, a thermosetting resin is preferably used. Specific examples of the thermosetting resin includes an epoxy resin, a phenol resin, a silicone resin, an unsaturated polyester resin, a urea resin, a melamine resin, an alkyd resin, resins containing them, and the like. The coating amount of the resin is preferably from 0.1 to 5.0 parts by weight with respect to 100 parts by weight of the magnetic core material (before resin coating).

Furthermore, in order to control the carrier characteristics, a conductive agent or a charge control agent may be incorporated into the coating resin. Examples of the conductive agent include conductive carbon, an oxide such as titanium oxide or tin oxide, various types of organic conductive agents, and the like. The addition amount thereof is from 0.25 to 20.0% by weight, preferably from 0.5 to 15.0% by weight and particularly preferably from 1.0 to 10.0%/o by weight, with respect to the solid content of the coating resin. Examples of the charge control agent include various types of charge control agents commonly used for toner, and various types of silane coupling agents. The kinds of the charge control agents and coupling agents usable are not particularly limited, and preferred are a charge control agent such as a nigrosine dye, a quaternary ammonium salt, an organic metal complex, or a metal-containing monoazo dye, an aminosilane coupling agent, a fluorine-based silane coupling agent, and the like. The addition amount thereof is preferably from 1.0 to 50.0% by weight, more preferably from 2.0 to 40.0% by weight, and particularly preferably from 3.0 to 30.0% by weight, with respect to the solid content of the coating resin.

As to the carrier, the rising-up speed (RQ) of charge amount is preferably 0.80 or more, and more preferably 0.85 or more. The rising-up speed of charge amount of the carrier can be determined by the same technique as in the rising-up speed of charge amount of the core material described above. In the case where the rising-up speed of charge amount of the carrier is 0.80 or more, in the case of forming a developer together with a toner, at an initial stage after toner supply, the toner scattering and image defects such as fog are further suppressed. The upper limit of the rising-up speed (RQ) of charge amount is not particularly limited and is typically 1.00 or less.

### Methods for Producing Magnetic Core Material for Electrophotographic Developer and Carrier for Electrophotographic Developer:

In producing a carrier for electrophotographic developer of the present invention, first, a magnetic core material for electrophotographic developer is produced. For producing the magnetic core material, primary materials (raw materials) are weighed in appropriate amounts, and then pulverized and mixed by a ball mill, a vibration mill or the like for 0.5 hours or more, preferably from 1 to 20 hours. The raw materials are not particularly limited. The pulverized product thus-obtained is pelletized by using a compression molding machine or the like, and then calcined at temperature from 700 to 1,200° C. to obtain a calcined product.

Then, the calcined product is pulverized by a ball mill, a vibration mill or the like. At this time, a wet pulverization in which water is added to the calcined product to form a slurry may be performed, and if desired, a dispersant, a binder or the like may be added to adjust a viscosity of the slurry. Furthermore, by regulating the size and composition of the media used in the pulverization, the pulverization time and the like, the degree of pulverization can be controlled. Then, the calcined product pulverized is granulated by a spray dryer to perform granulation, thereby obtaining a granulated product.

Furthermore, the granulated product thus-obtained is heated at 400 to 800° C. to remove the organic components such as the dispersant or binder added, and then maintained in an oxygen concentration controlled atmosphere at temperature from 800 to 1,500 for 1 to 24 hours to perform sintering. At this time, a rotary electric furnace, a batch electric furnace, a continuous electric furnace, or the like may be used, and the control of the oxygen concentration may be performed by introducing an inert gas such as nitrogen or a reducing gas such as hydrogen or carbon monoxide into the atmosphere at the time of sintering. Then, the sintered product thus-obtained is disintegrated and classified. Examples of the disintegration method include a method using a hammer crusher or the like. As the classification method, the existing method such as an air classification method, a mesh filtration method or a precipitation method may be used to regulate the particle size to an intended particle size.

Thereafter, if desired, an oxide film forming treatment can be performed by applying low temperature heating to the surface, thereby regulating the electric resistance. The oxide film forming treatment can be performed by heat treatment, for example, at 300 to 700° C. by using a common rotary electric furnace, batch electric furnace or the like. The thickness of the oxide film formed by the treatment is preferably from 0.1 nm to 5 μm. In the case of 0.1 nm or more, the effect of the oxide film layer is sufficient. In the case of 5 μm or less, decrease in the magnetization or the excessively high resistance can be suppressed. If desired, reduction may be performed before the oxide film forming treatment.

As the method for adjusting the content of the sulfur component in a magnetic core material, various techniques can be mentioned. Examples thereof include using a raw material having a small content of the sulfur component, and performing washing operation in the stage of pulverization of the calcined product. In addition, it is also effective to increase a flow rate of atmospheric gas introduced into a furnace at the time of calcination or sintering to make the sulfur component be easily discharged outside the system. In particular, the washing operation of slurry is preferably performed, and this can be performed, for example, by a technique in which after dehydration of the slurry, water is added again and wet pulverization is performed. In this case, in order to reduce the content of the sulfur component, the dehydration of the slurry and re-pulverization may be repeated.

As described later, in Examples, as an example of the technique for reducing the sulfur component, in the production of the granulated product, water is added to the calcined product, followed by performing wet pulverization to form a slurry, and after dehydrating the slurry obtained, a washing operation in which water is added again, followed by performing wet pulverization is performed. In addition, in the washing operation, the step of adding water after dehydration of the slurry, followed by performing wet pulverization may be repeated.

This is because the sulfur component elutes from the calcined product into water at the time of pulverization and the sulfur component eluted is discharged together with water at the time of dehydration, and as a result, the sulfur component in the magnetic core material is reduced. In addition, it is also effective to adjust various conditions in the washing operation in order to set the sulfur component to be within the range of the present invention. Examples of adjustment means include appropriate adjustment of purity of washing water depending on purity of raw material, temperature of washing water, addition amount of water with respect to a calcined product (diluted concentration), washing time, stirring strength during the washing (degree of dispersion), dehydration level (concentrated concentration), the number of times of washing, and the like.

Only by washing according to a simple method without adjusting the detailed conditions during the washing, it is absolutely difficult to achieve the sulfur component to be within the range of the present invention.

Furthermore, as described above, in a technique in which the dehydration operation, which is one example of the method for reducing the sulfur component according to the present invention, is not performed, the sulfur component eluted at the time of the pulverization is again dried without being discharged. As a result, it is inferred that a great part of the sulfur component remains in the granulated powder, and as described above, the content of the sulfur component cannot be adjust to be within the specific range.

As described above, it is desired that after the production of the magnetic core material, the surface of the magnetic core material is coated with a resin to from a carrier. The coating resin used is that described above. As a coating method, use can be made of a known method, for example, a brush coating method, a dry method, a spray dry system using a fluidized bed, a rotary dry system, or a dip-and-dry method using a universal agitator. In order to improve the surface coverage, the method using a fluidized bed is preferred. In the case where the resin is baked after the coating, any of an external heating system and an internal heating system may be employed, and, for example, a fixed or fluidized electric furnace, a rotary electric furnace or a burner furnace can be used. Alternatively, the baking with a microwave may be used. In the case where a UV curable resin is used as the coating resin, a UV heater is employed. The temperature for baking is varied depending on the resin used, and is desirably a temperature equal to or higher than the melting point or the glass transition point. For a thermosetting resin, a condensation-crosslinking resin or the like, the temperature is desirably raised to a temperature at which the curing sufficiently progresses.

### Developer:

The developer according to the present invention contains the carrier for electrophotographic developer described above and a toner. The particulate toner (toner particle) constituting the developer includes a pulverized toner particle produced by a pulverizing method and a polymerized toner particle produced by a polymerization method. As the toner particle used in the present invention, the toner particles obtained by any method can be used. The developer according to the present invention prepared as described above can be used in a copying machine, a printer, a FAX machine, a printing machine, and the like, which use a digital system employing a development system in which an electrostatic latent image formed on a latent image holder having an organic photoconductive layer is reversely developed with a magnetic brush of a two-component developer containing a toner and a carrier while applying a bias electric field. Furthermore, the developer is also applicable to a full-color machine and the like using an alternative electric field, which is a method in which when applying a development bias from a magnetic brush to an electrostatic latent image side, an AC bias is superimposed on a DC bias.

### EXAMPLE

The present invention will be described more specifically with reference to the examples below.

### Example 1

### (1) Production of Magnetic Core Material

The magnetic core material was produced in the following manner. Namely, raw materials were weighed so as to attain a composition ratio after sintering being 20% by mole of MnO and 80% by mole of Fe₂O₃, water was added thereto, and the mixture was pulverized and mixed by a wet ball mill for 5 hours, dried, and then maintained at 950° C. for one hour to perform calcination. As the MnO raw material and the Fe₂O₃ raw material, 2.7 kg of trimanganese tetraoxide and 22.3 kg of Fe₂O₃ were used, respectively.

### (1-1) Pulverization of Calcined Product

Water was added to the calcined product thus-obtained, the mixture was pulverized by a wet ball mill for 4 hours, and the resulting slurry was pressed and dehydrated by a filter press machine. To the cake obtained was added water, and the mixture was pulverized again by a wet ball mill for 4 hours to obtain slurry 1.

### (1-2) Granulation

To slurry 1 obtained was added PVA (polyvinyl alcohol) (aqueous 20% by weight solution) as a binder in an amount of 0.2% by weight with respect to the solid content, and a polycarboxylic acid dispersant was added so as to attain a slurry viscosity of 2 poise, and then granulated and dried by a spray drier to obtain a granulated product.

The particle size control of the granulated product was performed by a gyro shifter. Thereafter, the granulated product was heated at 650° C. in the air by using a rotary electric furnace to remove the organic components such as the dispersant and the binder.

### (1-3) Sintering

Then, the granulated product was maintained in an electric furnace at a temperature of 1,300° C. and an oxygen concentration of 0.1% for 4 hours to perform sintering. At this time, the temperature rising rate was set to 150° C./hour and the cooling rate was set to 110° C./hour. In addition, nitrogen gas was introduced from an outlet side of a tunnel-type electric furnace to adjust the internal pressure of the tunnel-type electric furnace from 0 to 10 Pa (positive pressure). Then, the sintered product was disintegrated by a hammer crusher, classified by a gyro shifter and a turbo classifier to perform particle size control, and subjected to magnetic separation to separate a low magnetic force product, thereby obtaining a ferrite particle (magnetic core material).

### (2) Production of Carrier

An acrylic resin (BR-52, produced by Mitsubishi Rayon Co., Ltd.) was dissolved in toluene to prepare an acrylic resin solution having a resin concentration of 10%. By using a universal mixing agitator, 100 parts by weight of the ferrite particle (magnetic core material) obtained in (1-3) and 2.5 parts by weight of the acrylic resin solution (0.25 parts by weight as a solid content because of the resin concentration of 10%) were mixed and agitated, thereby coating the resin on the surface of the ferrite particle while volatilizing toluene. After confirming that toluene was thoroughly volatilized, the residue was taken out from the apparatus, put into a vessel, and subjected to heating treatment at 150° C. for 2 hours in a hot air heating oven. Then, the product was cooled to room temperature, and the ferrite particle with the resin cured was taken out, the particles were disaggregated by using a vibrating sieve having an opening size of 200 mesh, and the non-magnetic material was removed by a magnetic separator. Thereafter, coarse particles were removed by again using the vibrating sieve having an opening size of 200 mesh, to obtain a ferrite carrier coated with resin.

### (3) Evaluation

As to the magnetic core material and carrier obtained, evaluations of various characteristics were made in the manner described below.

### <Volume Average Particle Size>

The volume average particle size (D₅₀) of the magnetic core material was measured by using a micro-track particle size analyzer (Model 9320-X100, produced by Nikkiso Co., Ltd.). Water was used as a dispersion medium. First, 10 g of a sample and 80 ml of water were put into a 100-ml beaker and a few drops of a dispersant (sodium hexametaphosphate) was added thereto. Subsequently, the mixture was dispersed for 20 seconds by using an ultrasonic homogenizer (UH-150 Model, produced by SMT. Co., Ltd.) at an output power level set at 4. Thereafter, foams formed on a surface of the beaker were removed, and the sample was loaded in the analyzer to perform the measurement.

### <Apparent Density>

The apparent density (AD) of the magnetic core material was measured in accordance with JIS Z2504 (Test Method for Apparent Density of Metal Powders).

### <Pore Volume>

The pore volume of the magnetic core material was measured by using mercury porosimeters (Pascal 140 and Pascal 240, produced by Thermo Fisher Scientific Inc.). A dilatometer CD3P (for powder) was used, and a sample was put in a commercially available gelatin capsule with a plurality of bored holes and the capsule was placed in the dilatometer. After deaeration in Pascal 140, mercury was charged, and a measurement in the low pressure region (0 to 400 kPa) was performed. Next, a measurement in the high pressure region (from 0.1 MPa to 200 MPa) was performed by Pascal 240. After the measurements, the pore volume of the ferrite particle was determined from data (the pressure and the mercury intrusion amount) for pore diameter of 3 μm or less converted from pressure. For determining the pore diameter, a control-cum-analysis software (PASCAL 140/240/440) associated with the porosimeter was used, and the calculation was carried out with the surface tension of mercury set at 480 dyn/cm and the contact angle set at 141.3°.

### <Ion Content (Ion Chromatography)>

The measurement of the content of cation components in the magnetic core material was performed in the following manner. First, to 1 g of ferrite particle (magnetic core material) was added 10 ml of ultrapure water (Direct-Q UV3, produced by Merck), and ultrasonic wave was irradiated for 30 minutes to extract the ion components. Next, the supernatant of the extract obtained was filtered with a disposable disc filter (W-25-5, pore size: 0.45 μm, produced by Tosoh Corp.) for a pre-treatment, to form a measurement sample. Then, the cation components included in the measurement sample were quantitatively analyzed by ion chromatography under the conditions described below to convert to the content ratio in the ferrite particle.

Analysis equipment: IC-2010, produced by Tosoh Corp.
Column: TSKgel SuperIC-Cation HSII (4.6 mm I.D.×1 cm+4.6 mm I.D.×10 cm)
Eluent: Solution prepared by dissolving 3.0 mmol of methanesulfonic acid and 2.7 mmol of 18-crown 6-ether in 1 L of pure water
Flow rate: 1.0 mL/min
Column temperature: 40° C.
Injection volume: 30 μL
Measurement mode: Non-suppressor system
Detector: CM detector
Standard sample: Cation mixed standard solution produced by Kanto Chemical Co., Inc.

On the other hand, the measurement of the content of anion components was performed by quantitative analysis of the anion components included in the ferrite particle with a combustion ion chromatography under the conditions described below.

Combustion equipment: AQF-2100H, produced by Mitsubishi Chemical Analytic Tech Co., Ltd.)
Sample amount: 50 mg
Combustion temperature: 1,100° C.
Combustion time: 10 minutes
Ar flow rate: 400 ml/min
O₂ flow rate: 200 ml/min
Humidified air flow rate: 100 ml/min
Absorption solution: Solution prepared by adding 1% by weight of hydrogen peroxide to the eluent described below
Analysis equipment: IC-2010, produced by Tosoh Corp.
Column: TSKgel SuperIC-Anion HS (4.6 mm I.D.×1 cm+4.6 mm ID.×10 cm)
Eluent: Aqueous solution prepared by dissolving 3.8 mmol of NaHCO₃ and 3.0 mmol of
Na₂CO₃ in 1 L of pure water
Flow rate: 1.5 mL/min
Column temperature: 40° C.
Injection volume: 30 μL
Measurement mode: Suppressor system
Detector: CM detector
Standard sample: Anion mixed standard solution produced by Kanto Chemical Co., Inc.

### <Charge Amount and Rising-Up Speed Thereof>

The measurements of the charge amounts (Q₂, Q₃₀) of the magnetic core material and carrier and the rising-up speed (RQ) thereof were performed in the following manner. First, a sample and a commercially available negatively chargeable toner (cyan toner for DocuPrint C3530, produced by Fuji Xerox Co., Ltd.) used in full-color printer were weighed so as to attain the toner concentration of 10.0% by weight and the total weight of 50 g. The sample and toner weighed were exposed under the normal temperature and normal humidity environment of temperature from 20 to 25° C. and humidity from 50 to 60% for 12 hours or more. Then, the sample and toner were charged into a 50-cc glass bottle and agitated at a rotation frequency of 100 rpm for 30 minutes to form a developer. On the other hand, as a charge amount measuring apparatus, use was made of an apparatus having a magnet roll including a total of 8 poles of magnets (magnetic flux density: 0.1 T) which N poles and S poles were alternately arranged on an inner side of an aluminum bare tube (hereinafter, a sleeve) of a cylindrical shape of 31 mm in diameter and 76 mm in length, and a cylindrical electrode arranged in an outer circumference of the sleeve with a gap of 5.0 mm from the sleeve. On the sleeve was uniformly adhered 0.5 g of the developer and then, while the magnet roll on the inner side was rotated at 100 rpm with the outer-side aluminum bare tube being fixed, a direct current voltage of 2,000 V was applied for 60 seconds between the outer electrode and the sleeve to transfer the toner to the outer-side electrode. At this time, an electrometer (an insulation resistance tester, Model 6517A, produced by Keithley Instruments, Inc.) was connected to the cylindrical electrode to measure the charge amount of the toner transferred. After the elapse of 60 seconds, the voltage applied was shut off, and after the rotation of the magnet roll was stopped, the outer-side electrode was taken out and the weight of the toner transferred to the electrode was measured. From the charge amount measured and the weight of the toner transferred, the charge amount (Q₃₀) was calculated. In addition, the charge amount (Q₂) was obtained in the same procedure except for changing the agitation time of the sample and the toner to 2 minutes. The rising-up speed (RQ) of charge amount was determined from the formula shown below.

RQ=Q₂/Q₃₀ [Math. 2]

### <Image Analysis>

The magnetic core material was subjected to image analysis in the manner described below and an uneven particle ratio and an average value of ratio A were obtained. First, 3,000 pieces of magnetic core materials were observed by using a particle size and shape distribution measuring device (PITA-1, produced by Seishin Enterprise Co., Ltd.) and a perimeter and an envelope perimeter were determined by using a software (Image Analysis) associated therewith. At this time, an aqueous xanthan gum solution having a viscosity of 0.5 Pa-s was prepared as a dispersion medium, and a mixture prepared by dispersing 0.1 g of the magnetic core material in 30 cc of the aqueous xanthan gum solution was used as a sample solution. By appropriately adjusting the viscosity of the dispersion medium as described above, the state in which the magnetic core material is dispersed in the dispersion medium can be maintained, and thus, the measurement can be smoothly performed. Furthermore, as to the measurement conditions, a magnification of an (objective) lens was set to 10 times, ND4×2 were used as filter, an aqueous xanthan gum solution having viscosity of 0.5 Pa's was used as carrier liquid 1 and carrier liquid 2, a flow rate of each liquid was set to 10 μl/sec, and a flow rate of the sample solution was set to 0.08 μl/sec.

Next, from the perimeter and envelope perimeter of the magnetic core material thus-obtained, a number distribution of the ratio A of perimeter to envelope perimeter was determined, and further, from the distribution, a ratio (uneven particle ratio) of particles having the ratio A of 1.08 or more and an average value of the ratio A were determined. Here, the ratio A was obtained according to the formula shown below.

Ratio A=perimeter/envelope perimeter [Math. 1]

In the evaluation of the magnetic core material, a variation degree of surface shape cannot be expressed only by defining the average value of the ratio A. Further, it is also insufficient only to define a grain size of surface or an average size of grain boundary with respect to the average particle size. Moreover, even when the variation degree described above is expressed based on limited sampling number of ranging approximately from several tens to 300, it cannot be said that the reliability is high. Therefore, in order to solve these problems, the measurements of the perimeter and envelope perimeter were performed in the manner as described above.

### Example 2

### (1) Production of Magnetic Core Material

The magnetic core material and carrier were produced in the following manner.

Namely, raw materials were weighed so as to attain a composition ratio after sintering being 40.0% by mole of MnO, 10.0% by mole of MgO and 50.0% by mole of Fe₂O₃, and with respect to the 100 parts by weight of these metal oxides, 1.5 parts by weight of ZrO₂ was added. As the raw material, 16.9 kg of Fe₂O₃, and as the MnO raw material, the MgO raw material and the ZrO₂ raw material, 6.5 kg of trimanganese tetraoxide, 1.2 kg of magnesium hydroxide and 0.4 kg of ZrO₂ were used, respectively.

### (1-1) Pulverization of Calcined Product

The mixture was pulverized and mixed by a wet ball mill for 5 hours, dried, and then maintained at 950° C. for one hour to perform calcination. Water was added to the calcined product thus-obtained, the mixture was pulverized by a wet ball mill for 4 hours, and the resulting slurry was dehydrated by a vacuum filtration machine. To the cake obtained was added water, and the mixture was pulverized again by the wet ball mill for 4 hours to obtain slurry 2.

### (1-2) Granulation

To slurry 2 obtained was added PVA (aqueous 20% by weight solution) as a binder in an amount of 0.2% by weight with respect to the solid content, and a polycarboxylic acid dispersant was added so as to attain a slurry viscosity of 2 poise, and then granulated and dried by a spray drier. Then, the granulated product obtained was heated at 650° C. in the air to remove the organic component such as the dispersant and the binder.

### (1-3) Sintering

Then, the granulated product was maintained in an electric furnace under conditions of a temperature of 1,250° C. and an oxygen concentration of 0.3% for 6 hours to perform sintering. At this time, the temperature rising rate was set to 150° C./hour and the cooling rate was set to 110° C./hour. In addition, nitrogen gas was introduced from an outlet side of a tunnel-type electric furnace to adjust the internal pressure of the tunnel-type electric furnace from 0 to 10 Pa (positive pressure). The sintered product obtained was disintegrated by a hammer crusher, then classified by a gyro shifter and a turbo classifier to perform particle size control, and subjected to magnetic separation to separate a low magnetic force product, thereby obtaining a ferrite particle.

### (1-4) Oxide Film Forming Treatment

The ferrite particle thus-obtained was maintained in a rotary atmosphere furnace kept at 500° C. for one hour to perform the oxide film forming treatment on the surface of the ferrite particle. The ferrite particle subjected to the oxide film forming treatment as described above was subjected to magnetic separation and mixing to obtain a carrier core material (magnetic core material).

Thereafter, as to the magnetic core material obtained, the production of carrier and evaluations were performed in the same manner as in Example 1.

### Example 3

### (1) Production of Magnetic Core Material

The magnetic core material and carrier were produced in the following manner. Namely, raw materials were weighed so as to attain a composition ratio after sintering being 10.0% by mole of MnO, 13.3% by mole of Li₂O and 76.7% by mole of Fe₂O₃, and water was added so as to attain a solid content of 500. Furthermore, an aqueous lithium silicate solution with 20% in terms of SiO₂ was added thereto so as to attain an amount of Si being 10,000 ppm with respect to the solid content. As the raw material, 21.9 kg of Fe₂O₃, and as the MnO raw material and the Li₂O raw material, 1.4 kg of trimanganese tetraoxide and 1.8 kg of lithium carbonate were used, respectively.

### (1-1) Pulverization of Calcined Product

The mixture was pulverized and mixed by a wet ball mill for 5 hours, dried, and then calcined at 1,000° C. in the air. Water was added to the calcined product thus-obtained, the mixture was pulverized by a wet ball mill for 4 hours, and the resulting slurry was dehydrated by a centrifugal dehydration machine. To the cake obtained was added water, and the mixture was pulverized again by the wet ball mill for 4 hours to obtain slurry 3.

### (1-2) Granulation

To slurry 3 obtained was added PVA (aqueous 20% by weight solution) as a binder in an amount of 0.2% by weight with respect to the solid content, and a polycarboxylic acid dispersant was added so as to attain a slurry viscosity of 2 poise, and then granulated and dried by a spray drier. Then, the granulated product obtained was heated at 650° C. in the air to remove the organic component such as the dispersant and the binder.

### (1-3) Sintering

Then, the granulated product was sintered under conditions of a temperature of 1,165° C. and an oxygen concentration of 1% by volume for 16 hours to obtain a sintered product. At this time, the temperature rising rate was set to 150° C./hour and the cooling rate was set to 110° C./hour. In addition, nitrogen gas was introduced from an outlet side of a tunnel-type electric furnace to adjust the internal pressure of the tunnel-type electric furnace from 0 to 10 Pa (positive pressure). The sintered product obtained was disintegrated by a hammer crusher, then classified by a gyro shifter and a turbo classifier to perform particle size control, and subjected to magnetic separation to separate a low magnetic force product, thereby obtaining a carrier core material (magnetic core material).

Thereafter, as to the magnetic core material obtained, the production of carrier and evaluations were performed in the same manner as in Example 1.

### Example 4

The production of magnetic core material and carrier and the evaluations were performed in the same manner as in Example 1, except for using a raw material of a different lot as the Fe₂O₃ raw material.

### Example 5

The production of magnetic core material and carrier and the evaluations were performed in the same manner as in Example 3, except for using a raw material of a different lot as the Fe₂O₃ raw material.

### Example 6 (Comparative Example)

The production of magnetic core material and carrier and the evaluations were performed in the same manner as in Example 1, except for changing the conditions of the pulverization of calcined product to those described below. Namely, in (1-1) Pulverization of calcined product in Example 1, water was added to the calcined product, and the mixture was pulverized by a wet ball mill for 7 hours to obtain slurry 6.

### Example 7 (Comparative Example)

The production of magnetic core material and carrier and the evaluations were performed in the same manner as in Example 2, except for changing the conditions of the pulverization of calcined product to those described below. Namely, in (1-1) Pulverization of calcined product in Example 2, water was added to the calcined product, and the mixture was pulverized by a wet ball mill for 7 hours to obtain slurry 7.

### Example 8 (Comparative Example)

The production of magnetic core material and carrier and the evaluations were performed in the same manner as in Example 3, except for changing the conditions of the pulverization of calcined product to those described below. Namely, in (1-1) Pulverization of calcined product in Example 3, water was added to the calcined product, and the mixture was pulverized by a wet ball mill for 7 hours to obtain slurry 8.

### Example 9 (Comparative Example)

The production of magnetic core material and carrier and the evaluations were performed in the same manner as in Example 1, except for changing the conditions of the pulverization of calcined product to those described below. Namely, in (1-1) Pulverization of calcined product in Example 1, water was added to the calcined product, the mixture was pulverized by a wet ball mill for 2 hours, and the resulting slurry was pressed and dehydrated by a filter press machine. The operation of adding water, pulverizing for 2 hours and dehydrating was further repeated twice similarly, and then water was added to the cake obtained, and the mixture was pulverized again by the wet ball mill for 2 hours to obtain slurry 9.

### Example 10 (Comparative Example)

The production of magnetic core material and carrier and the evaluations were performed in the same manner as in Example 2, except for changing the conditions of the pulverization of calcined product to those described below. Namely, in (1-1) Pulverization of calcined product in Example 2, water was added to the calcined product, the mixture was pulverized by a wet ball mill for 2 hours, and the resulting slurry was dehydrated by a vacuum filtration machine. The operation of adding water, pulverizing for 2 hours and dehydrating was further repeated twice similarly, and then water was added to the cake obtained, and the mixture was pulverized again by the wet ball mill for 2 hours to obtain slurry 10.

### Example 11 (Comparative Example)

The production of magnetic core material and carrier and the evaluations were performed in the same manner as in Example 3, except for changing the conditions of the pulverization of calcined product to those described below. Namely, in (1-1) Pulverization of calcined product in Example 3, water was added to the calcined product, the mixture was pulverized by a wet ball mill for 2 hours, and the resulting slurry was dehydrated by a centrifugal dehydration machine. The operation of adding water, pulverizing for 2 hours and dehydrating was further repeated twice similarly, and then water was added to the cake obtained, and the mixture was pulverized again by the wet ball mill for 2 hours to obtain slurry 11.

### Results

The evaluation results obtained in Examples 1 to 11 were as shown in Tables 1 and 2. In Examples 1 to 5, which are the examples of the present invention, the magnetic core material had excellent charge amount (Q₂, Q₃₀) and high rising-up speed (RQ) of charge amount, and the rising-up speed of charge amount of carrier was also high. In addition, the ratio (uneven particle ratio) of particles having the ratio A of 1.08 or more was small and it is expected to sufficiently exert the carrier scattering suppressing effect. In Examples 1 to 3, all of the charge amount (Q₂, Q₃₀), the rising-up speed (RQ) of charge amount and the rising-up speed of charge amount of carrier were large and thus, more excellent effects can be achieved. On the other hand, in Examples 6 to 8, which are the comparative examples, the magnetic core material had the excessively high content of sulfur component (SO₄) and as a result, the rising-up speed (RQ) of charge amount was not sufficient. Furthermore, in Examples 9 to 11, which are the comparative examples, the magnetic core material had the excessively low content of sulfur component (SO₄) and as a result, the ratio (uneven particle ratio) of particles having the ratio A of 1.08 or more was large, and as a result, a problem of the carrier scattering is a matter of concern. From these results, it can be seen that according to the present invention, a magnetic core material for electrophotographic developer and a carrier for electrophotographic developer, each of which is excellent in the rising-up of charge amount, can suppress the carrier scattering and can stably provide good images, and a developer containing the carrier can be provided.

TABLE 1

| | Magnetic Core Material | | | | | | | | | | | | | |
|---|---|---|---|---|---|---|---|---|---|---|---|---|---|---|
| | D₅₀ | AD | Pore Volume | Ion Content (ppm) | | | | | | | | | | |
| | (μm) | (g/cm³) | (mm³/g) | F⁻ | Cl⁻ | Br⁻ | NO₂⁻ | NO₃⁻ | SO₄²⁻ | Na⁺ | NH₄⁺ | Mg²⁺ | Ca²⁺ | K⁺ |
| Example 1 | 40.1 | 2.36 | 5 | 0.4 | 2.3 | N.D. | 0.4 | 1.0 | 2.1 | 6.8 | N.D. | 2.2 | 28.4 | 5.2 |
| Example 2 | 37.5 | 2.33 | 3 | 0.8 | 3.7 | N.D. | 0.3 | 1.2 | 6.0 | 11.0 | N.D. | 2.5 | 17.8 | 3.8 |
| Example 3 | 39.0 | 2.17 | 16 | 1.5 | 1.6 | N.D. | 0.6 | 0.7 | 29.5 | 5.8 | N.D. | 2.8 | 20.7 | 3.7 |
| Example 4 | 40.2 | 2.36 | 4 | 0.5 | 2.1 | N.D. | 0.5 | 1.1 | 1.3 | 6.2 | N.D. | 2.2 | 25.5 | 5.0 |
| Example 5 | 39.2 | 2.16 | 17 | 1.6 | 1.5 | N.D. | 0.5 | 0.8 | 43.0 | 6.4 | N.D. | 2.7 | 22.2 | 3.9 |
| Example 6* | 40.5 | 2.38 | 4 | 0.5 | 3.4 | N.D. | 0.6 | 1.5 | 88.3 | 7.1 | N.D. | 1.9 | 30.9 | 4.5 |
| Example 7* | 36.8 | 2.34 | 5 | 0.6 | 5.0 | N.D. | 0.4 | 3.9 | 157 | 11.7 | N.D. | 3.3 | 18.6 | 4.4 |
| Example 8* | 39.1 | 2.16 | 16 | 2.0 | 2.9 | N.D. | 0.4 | 1.6 | 286 | 8.7 | N.D. | 3.4 | 25.6 | 2.9 |
| Example 9* | 39.9 | 2.38 | 2 | 0.6 | 1.3 | N.D. | 0.5 | 0.6 | 0.7 | 5.2 | N.D. | 2.1 | 14.3 | 3.9 |
| Example 10* | 36.2 | 2.33 | 3 | 0.6 | 1.5 | N.D. | 0.3 | 0.9 | 0.7 | 4.9 | N.D. | 2.5 | 12.8 | 3.4 |
| Example 11* | 38.7 | 2.15 | 18 | 1.1 | 0.7 | N.D. | 0.4 | 0.5 | 0.9 | 1.8 | N.D. | 2.4 | 17.3 | 3.6 |

*indicates the comparative example.
N.D. indicates that it was not detected.

TABLE 2

| | Magnetic Core Material | | | | | Carrier | | |
|---|---|---|---|---|---|---|---|---|
| | Charge Amount | | | Image Analysis | | Charge Amount | | |
| | Q₂ | Q₃₀ | | Uneven Particle Ratio | Average Value of | Q₂ | Q₃₀ | |
| | (μC/g) | (μC/g) | RQ | (%) | Ratio A | (μC/g) | (μC/g) | RQ |
| Example 1 | 38.9 | 41.5 | 0.94 | 7.8 | 1.05 | 34.6 | 37.8 | 0.92 |
| Example 2 | 42.9 | 46.5 | 0.92 | 5.8 | 1.05 | 37.5 | 41.3 | 0.91 |
| Example 3 | 34.8 | 39.5 | 0.88 | 3.8 | 1.04 | 31.7 | 35.7 | 0.89 |
| Example 4 | 39.6 | 41.8 | 0.95 | 9.2 | 1.05 | 36.1 | 38.8 | 0.93 |
| Example 5 | 29.5 | 36.4 | 0.81 | 3.7 | 1.04 | 26.7 | 33.3 | 0.80 |
| Example 6* | 26.6 | 35.1 | 0.76 | 4.1 | 1.05 | 23.4 | 31.3 | 0.75 |
| Example 7* | 19.9 | 25.7 | 0.77 | 3.4 | 1.04 | 15.3 | 21.4 | 0.71 |
| Example 8* | 18.8 | 29.5 | 0.64 | 1.8 | 1.04 | 13.9 | 22.8 | 0.61 |
| Example 9* | 40.8 | 43.0 | 0.95 | 13.1 | 1.04 | 36.7 | 39.4 | 0.93 |
| Example 10* | 44.4 | 47.3 | 0.94 | 12.6 | 1.05 | 38.1 | 42.0 | 0.91 |
| Example 11* | 36.6 | 39.8 | 0.92 | 10.9 | 1.05 | 33.3 | 36.9 | 0.90 |

*indicates the comparative example.

### INDUSTRIAL APPLICABILITY

According to the present invention, a magnetic core material for electrophotographic developer which is excellent in the rising-up of charge amount, can suppress the carrier scattering, and can stably provide good images can be provided. Furthermore, a carrier for electrophotographic developer and a developer each of which contains the magnetic core material can be provided. Moreover, a method for producing the magnetic core material for electrophotographic developer, a method for producing the carrier for electrophotographic developer, and a method for producing the developer can be provided.

While the present invention has been described in detail and with reference to specific embodiments thereof, it will be apparent to those skilled in the art that various changes and modifications can be made therein without departing from the spirit and scope of the present invention.

This application is based on a Japanese patent application (No. 2017-162630) filed on Aug. 25, 2017, and the contents thereof are incorporated herein by reference.

1. A magnetic core material for electrophotographic developer, comprising a sulfur component in a content of from 1 to 45 ppm in terms of a sulfate ion.

2. The magnetic core material for electrophotographic developer according to claim 1, wherein in a number distribution of a ratio A of a perimeter to an envelope perimeter, a ratio of particles having the ratio A of 1.08 or more is 10% or less.

3. The magnetic core material for electrophotographic developer according to claim 1, wherein the content of the sulfur component is from 2 to 30 ppm in terms of a sulfate ion.

4. The magnetic core material for electrophotographic developer according to claim 2, wherein the ratio of particles having the ratio A of 1.08 or more is 8% or less.

5. The magnetic core material for electrophotographic developer according to claim 1, wherein the magnetic core material has a volume average particle diameter (D₅₀) being from 25 to 50 μm, and an apparent density (AD) being from 2.0 to 2.7 g/cm³.

6. The magnetic core material for electrophotographic developer according to claim 1, wherein the magnetic core material has a pore volume being from 0.1 to 20 mm³/g.

7. The magnetic core material for electrophotographic developer according to claim 1, wherein the magnetic core material has a ferrite composition comprising at least one element selected from Mn, Mg, Li, Sr, Si, Ca, Ti, and Zr.

8. A carrier for electrophotographic developer comprising the magnetic core material for electrophotographic developer as described in claim 1, and a coating layer comprising a resin provided on a surface of the magnetic core material.

9. A developer comprising the carrier as described in claim 8 and a toner.

10. (canceled)

11. (canceled)

12. (canceled)

13. (canceled)
